(19) United States
(12) Patent Application Publication
(10) Pub. No.: US 2008/0314819 A1
(43) Pub. Date: Dec. 25, 2008

(54) Filter assembly center tube with upstream diverter

(76) Inventors: David Ferreira, Glastonbury, CT (US); Joseph H. Litwinas, Coventry, CT (US)

Correspondence Address: ALIX YALE & RISTAS LLP, 750 MAIN STREET, SUITE 1400, HARTFORD, CT, 06103, US

(21) Appl. No.: 12/157,876

(22) Filed: Jun. 13, 2008

Related U.S. Application Data
(60) Provisional application No. 60/934,563, filed on Jun. 14, 2007.

(51) Int. Cl. F02M 37/22

(52) U.S. Cl. 210/438

(57) ABSTRACT

A diverter module is incorporated into a filter cartridge. The module employs a radial passage which diverts fluid to be filtered to the radial periphery of a filter element. The filtered fluid flows inwardly and axially through a transfer passage for discharge from the filter cartridge.

### CROSS-REFERENCE TO RELATED APPLICATION

This application claims the priority of U.S. Provisional Patent Application No. 60/934,563 filed on Jun. 14, 2008.

### BACKGROUND

This application relates to fuel filter assemblies. More particularly, this application relates to fuel filters employed for removing particulate matter and water from fuel supplied to an internal combustion engine.

A fuel filter assembly which is addressed by the present application typically employs a header and a replaceable cartridge which is mounted to the header. The header provides an inlet and a coaxial outlet for the filter cartridge. The cartridge typically has a canister-like exterior which houses a circumferential pleated filter element and communicates at one end with the header.

There are different types of flow paths through a filter cartridge. In the “normal flow” pattern, fluid to be filtered typically communicates generally axially from a central inlet at one end of the cartridge, flows axially to the remote end of the filter element, flows generally radially outwardly from the filter element, then flows between the element and the housing and through the filter element and toward the inlet end of the cartridge wherein the filtered fluid is directed to the outlet of the header. During this flow, the filter element, which is typically a pleated circumferential form, removes particulate matter from the fuel and also functions to coalesce and to remove the trapped water from the fuel.

In filter assembly configurations having a flow path which may be referred to as a “diverted reverse flow” pattern, the fluid to be filtered flow path is diverted radially upstream of the filter element generally around the radial outside of the circumferential filter element and through the element toward the central interior space and axially toward the central portion of the filter cartridge. This reverse type of flow for some applications has advantages in that enhanced water separation may be provided by more effective exposure to the initial filter surface area of the filter element.

Accordingly, in some applications it is desirable to use a diverted reverse flow filter cartridge in conjunction with a conventional header which is configured for normal filter flow and is installed with the original engine equipment.

### SUMMARY

Briefly stated, a filter cartridge comprises a housing having a central axial opening with a seal which receives a central axial conduit. A pleated filter element is received in the housing and forms a central filtered region and a peripheral unfiltered region. A diverter module is disposed in the housing and comprises a distribution chamber having a conduit opening for receiving an axial conduit and a closed end. At least one radial passage opens through a peripheral surface. An outlet chamber generally surrounds a first portion of the distribution chamber and communicates with the axial opening. A cover is disposed over one end of the filter and extends radially from the distribution chamber, and is spaced from the passage. The cover has a generally axial opening which is in fluid communication via a transfer passage with said outlet chamber along a path radially exteriorly of the distribution chamber. Fluid to be filtered enters a central axial conduit into the distribution chamber is directed radially to the unfiltered region, passes through the filter element to the interior filtered region and generally axially flows to the outlet chamber and central axial opening.

The diverter module is preferably a one piece moulded member. In one embodiment, there are two radial passages. A peripheral flange engages an end portion of the filter. The outlet chamber and the cover are generally axially symmetric. The transfer passage is at least partially defined by a surface which tapers from the cover to the outlet chamber. The cover extends a radial distance which is greater than the radial distance of the periphery of the outlet chamber.

A central tube module for a filter cartridge is preferably a one piece moulded member which includes a diverter portion forming a distribution chamber. The chamber has an open end and a closed end and at least one radial passage opening through a peripheral surface. An outlet chamber generally surrounds the open end of the distribution chamber and extends beyond the distribution chamber. A cover radially extends from the diverter portion and is spaced from the passage for directing flow from the passage to the outside unfiltered region of the filter element. The cover defines an axial opening which is in fluid communication via a transfer passage with the outer chamber and is disposed radially exteriorly with respect to the distribution chamber. In one embodiment, there are two radial passages and two generally axial openings and transfer passages of semi-annular form.

### BRIEF DESCRIPTION OF THE DRAWING

FIG. 1 is a sectional view, partly in schematic, of a center tube module for a filter cartridge, showing the diverted reverse flow diagram;

FIG. 2 is a perspective view of the center tube module of FIG. 1;

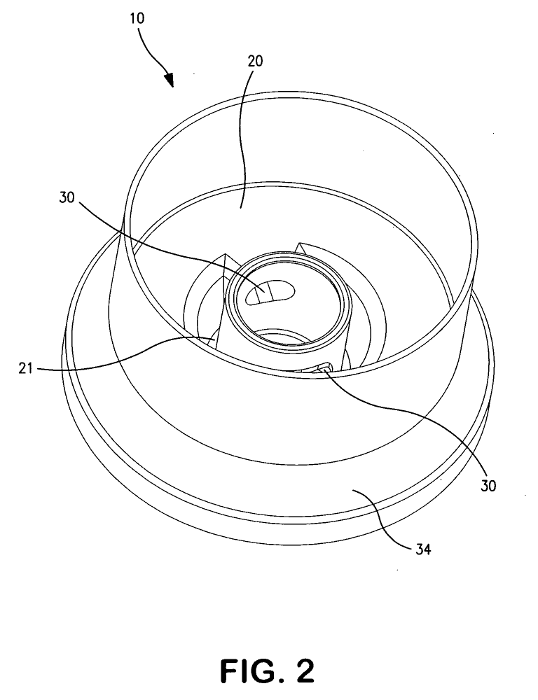

FIG. 3 is a perspective cut-away view of the center tube module of FIG. 2 with the center tube module being illustrated at a different orientation than that of FIG. 2;

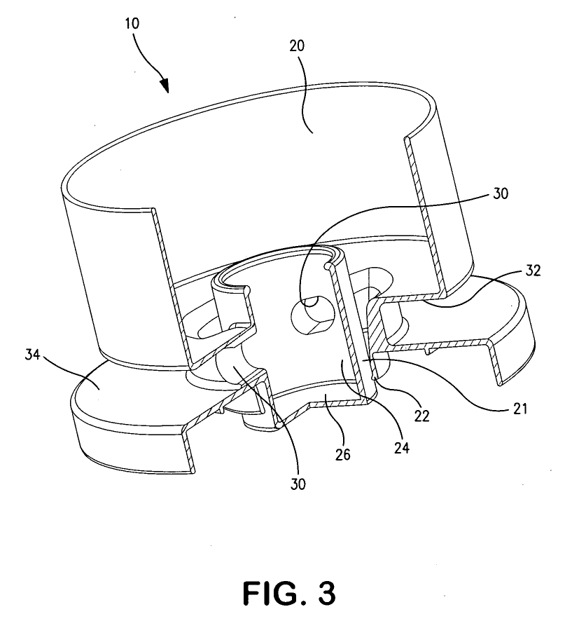

FIG. 4 is a perspective cut-away view of the center tube module of FIG. 2 with the module being oriented at a second different orientation than that of FIG. 3;

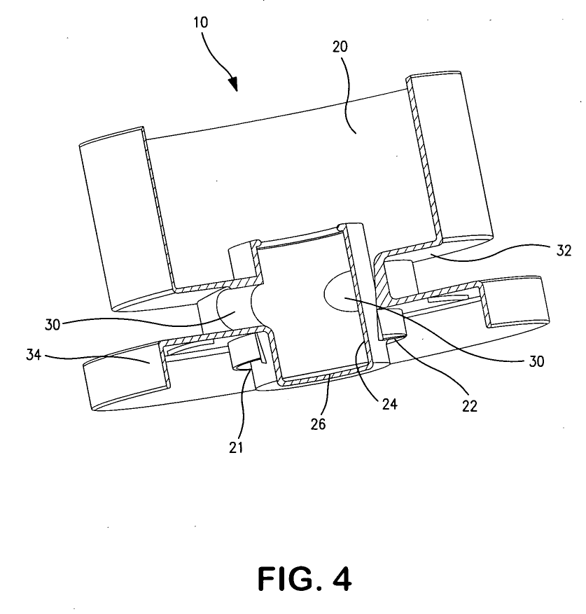

FIGS. 5A and 5B are correspondingly comparative sectional views, partly in schematic, of a representative normal flow filter cartridge and a filter cartridge with the center tube module of FIG. 1 and the respective fuel flow patterns illustrated schematically.

### DETAILED DESCRIPTION

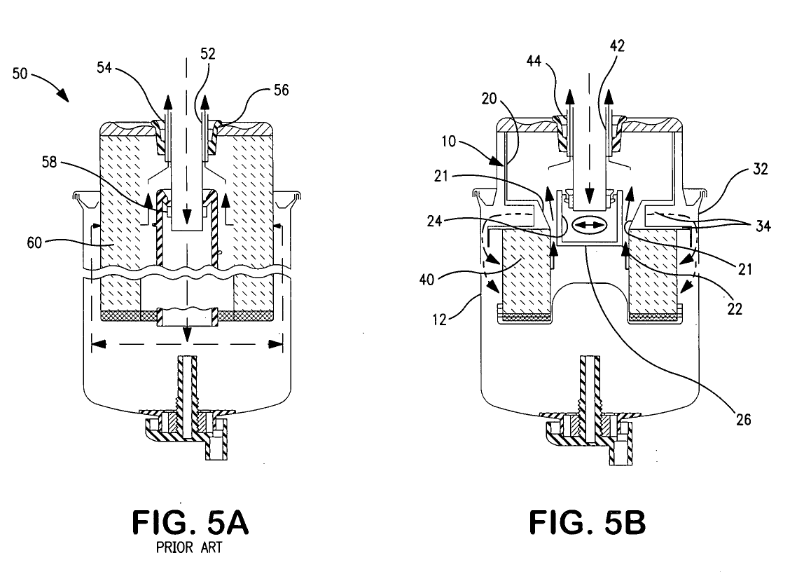

A center tube module designated generally by the numeral 10 is employed in a filter cartridge 12 (FIG. 5B) and functions as a diverter module so that the cartridge 12 imposes an upstream diverted flow path and is adapted to communicate with a normal flow header (not illustrated) for the cartridge. Communication between the conventional normal flow header is provided by a pair of coaxial conduits 52, 54 with the inner 52 conduit functioning as the inlet (unfiltered) passage to the cartridge and the outer conduit 54 functioning as the outlet (filtered) passage from the cartridge.

The center tube module 10 is preferably a one piece moulded element which is configured to define the inlet and outlet paths between the header and the cartridge. The center tube module 10 includes a central annular chamber 20 which inwardly tapers to internal generally axial transfer passages 21 terminating in openings 22. The passages 21 and openings 22 are semi-annular in shape. Disposed centrally and axially of the chamber is a central inlet distribution chamber 24 which has an end wall 26 terminating slightly below the outlet of the openings 22. The distribution chamber includes opposed radial passages 30. Alternatively, multiple angularly spaced passages may be provided. The passages 30 open into an intermediate annulus 32 for distribution (upstream generally radial diversion) of the fluid to be filtered. The annulus 32 is partially defined by an integral cover plate 34 which on its opposite side receives one end of the filter element 40. The plate 34 preferably has an integral peripheral flange 36 which engages peripheral end portions of the filter element 40 to facilitate retention. The radial passages 30 are preferably disposed between the end of the filter element (upper in the drawings) and the communication end of the cartridge.

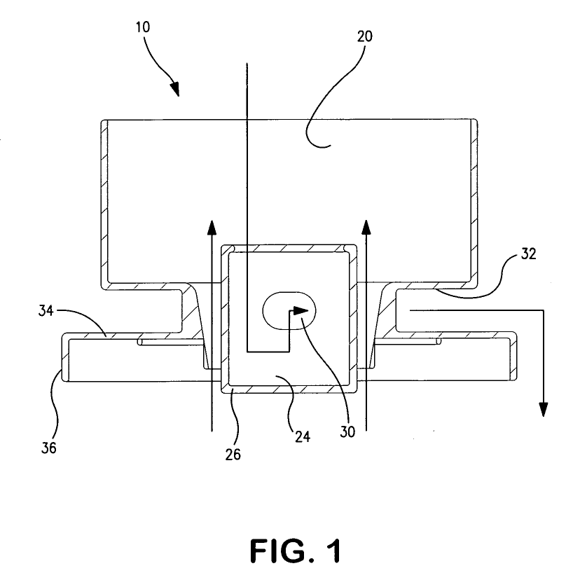

The fluid to be filtered follows the path illustrated in FIG. 1 through the inlet, through the radial passages 30, and about the annulus 32, and then flows generally upstream of the filter element 40 toward the remote (non-communication) end of the filter cartridge. The fluid then inwardly flows from outwardly through the filter element which is generally, circumferentially disposed within the cartridge about the central axis of the filter element. The filtered fuel then flows and is received inwardly from the filter element and flows axially through openings 22 via transfer passages 21 to the outlet annulus (which is defined between the coaxial tubes) for discharge through the header as would be the flow path for the conventional, normal flow header.

The structure and function of the center tube element 10 may best be appreciated with reference to FIGS. 5A and 5B which illustrates a side by side representation and comparison of a normal flow cartridge (FIG. 5A) with an upstream diverted reverse flow cartridge 12 (FIG. 5B) incorporating the center tube 10. The inlet or dirty (unfiltered) fuel is schematically shown by a broken line. The clean fuel or outlet (filtered) fuel is shown by a heavy line in the schematic flow diagram.

In the related fuel filter cartridge (FIG. 5A), which is representative for a normal flow cartridge and designated generally by the numeral 50, a pair of co-axial conduits 52 and 54 communicate with the normal flow header (not illustrated). Grommets 56 and 58 seal the tubes with the cartridge. For the normal flow element 50, the inlet fluid flows axially initially into the cartridge through the central inlet cartridge and flows generally axially along the internal axial extant of the filter element, then outwardly as shown by the arrows, and inwardly through the filter element 60, wherein it is directed generally axially through the outlet via the outer coaxial outlet conduit 54.

By contrast, element cartridge 12 illustrated in FIG. 5B employs the center tube module 10 wherein the inlet fuel flow from the inlet conduit 42 is distributed generally radially via passages 30 upstream of the filter element 40, then axially and then generally radially inwardly through the filter element and generally axially (upwardly) through the openings 22 to transfer passages 21, into chamber 20 and through the outer coaxial outlet conduit 44 into the header.

It will be appreciated that the center tube 10 alters the conventional flow path for the normal header cartridge since in the normal header fuel flows initially axially into the filter cartridge and transverses the axial extant of the filter element at which the fuel is now diverted radially and outwardly upstream of the filter element for flow inwardly to a central part of the element for flow parallel but surrounding the central inlet path. The fuel which is filtered then would flow into the opening 22, through the passage 21 and into the annular chamber 20 wherein it would eventually flow through the conventional outlet passages in the normal flow header. In sum, the inlet/outlet conduit relationship is the same for cartridge 12 (FIG. 5B) and cartridge 50 (FIG. 5A).

What is claimed:

1. A filter cartridge comprising:
a housing having a central axial opening to receive central axial conduit;
a pleated filter element received in said housing and forming a central filtered region and a peripheral unfiltered region; and
a diverter module disposed in said housing and comprising:
a distribution chamber having an opening for receiving an axial conduit and a closed end and at least one radial passage opening through a peripheral surface;
an outlet chamber generally surrounding a first portion of said distribution chamber and communicating with said axial opening;
a cover disposed over one end of said filter element and extending radially from said distribution chamber and spaced from said passage, said cover having a generally axial opening which is in fluid communication via a transfer passage with said outlet chamber along a path radially exteriorly of said distribution chamber,
wherein fluid to be filtered enters a central axial conduit into said distribution chamber, is directed radially to said unfiltered regions, passes through said filter element to said filtered region and generally axially flows to said outlet chamber and central axial opening.

2. The filter cartridge of claim 1, wherein said diverter module is a one piece moulded member.

3. The filter cartridge of claim 1, wherein there are two radial passages.

4. The filter cartridge of claim 1, wherein said cover has a peripheral flange which engages an end portion of said filter.

5. The filter cartridge of claim 1, wherein said outlet chamber and said cover are generally axially symmetric.

6. The filter cartridge of claim 1, wherein said transfer passage is at least partially defined by a surface which tapers from said outlet chamber to said cover.

7. The filter cartridge of claim 1, wherein said cover extends a radial distance which is greater than the radial distance of the periphery of said outlet chamber.

8. A central tube module for a filter cartridge comprising:
a diverter portion forming a distribution chamber defining a central axis and having an open end and a closed end and at least one radial passage opening through a peripheral surface;
an outlet chamber generally surrounding said first open end of said distribution chamber and extending beyond said distribution chamber;
a cover extending generally radially from said diverter portion and spaced from said passage, said cover having a an opening to a transfer passage which is in fluid communication with said outlet chamber radially exteriorly with respect to said distribution chamber.

9. The module of claim 8 wherein there are two radial passages.

10. The module of claim 8 wherein the module is a one piece moulded member.

11. The module of claim 8 wherein there are two openings and transfer passages.

12. The module of claim 11 where each said transfer passage is at least partially defined by a surface which tapers from said outlet to said cover.
